(19) United States
(12) Patent Application Publication
(10) Pub. No.: US 2016/0341534 A1
(43) Pub. Date: Nov. 24, 2016

(54) MEASURING DEVICE

(71) Applicant: Steven B. Joy, Goleta, CA (US)

(72) Inventor: Steven B. Joy, Goleta, CA (US)

(21) Appl. No.: 14/985,288

(22) Filed: Dec. 30, 2015

Related U.S. Application Data
(60) Provisional application No. 62/164,151, filed on May 20, 2015.

(51) Int. Cl. G01B 5/14

(52) U.S. Cl. CPC G01B 5/14

(57) ABSTRACT

Described herein are measuring devices that can be configured to determine a pre-set value of an object, for example, its center. The measuring devices described herein can comprise a reduced number of parts, making the devices less likely to malfunction and break down and decreasing manufacturing costs. In some embodiments, these devices can comprise a manually-operated primary moveable component, an automatically-operated intermediate component, a stationary base component and a cooperation mechanism allowing interaction of the various components. In some embodiments, these devices can continuously and automatically find the center of an object. In some embodiments, these devices can be operated with a single hand.

### CROSS REFERENCE TO RELATED APPLICATIONS

This application claims the benefit of U.S. Provisional Application Ser. No. 62/164,151 to Steven B. Joy, entitled MEASURING DEVICE, filed on May 20, 2015, which is hereby incorporated herein in its entirety by reference.

### BACKGROUND

1. Field of the Invention

Described herein are devices relating generally to measuring objects, for example, linear dimensions of objects, and specifically to the determination and verification of pre-set values, for example, determination of the center of an object.

2. Description of the Related Art

Throughout the ages, humankind has created various tools to facilitate the measuring of linear dimensions of objects, for example, the length, width and height of an object. From the basic ruler, to the tape measure, to the protractor, various conventional measuring devices are utilized to this very day.

Various conventional tools are used to determine the center of an object, including various clamp-like devices. Some issues with conventional center-determining devices are that they are unnecessarily complicated and comprise several components. This increases their cost of manufacture, and with the inclusion of many parts, for example, small and/or moving parts, also increases the likelihood of a component failing, resulting in device malfunction. Furthermore, conventional center-determining devices are difficult to operate with a single hand, requiring a user to occupy both of his or her hands with the operation of the device, such that his or her hands are not free to operate other devices or maneuver an object to be measured with a free hand. Additionally, many conventional devices require the use of a straight edge or parallel edges and further require the use of numerical numbers and mathematical calculations.

### SUMMARY

Described herein are efficient measuring devices capable of verifying and/or determining a pre-set value, for example, the center of an object. In some embodiments, devices incorporating features of the present invention are configured such that the devices can be efficiently operated with only a single hand. In some embodiments, the number of parts the device comprises are reduced, resulting in easy and cost-efficient manufacturing of the device and a fewer number of device parts, resulting in a more sturdy and stable device.

In one embodiment, a measuring device comprises a base component comprising at least one first jaw structure, a primary moveable component moveably connected to the base component, the primary moveable component comprising at least one second jaw structure, and an intermediate moveable component comprising at least a first stop face at least partially aligned with the at least one first jaw structure and a second stop face at least partially aligned with the at least one second jaw structure, the intermediate moveable component configured to move in response to movement of the primary moveable component.

In another embodiment, a measuring device comprises a base component comprising at least one first interactive structure, a primary moveable component moveably connected to the base component, the primary moveable component comprising at least one second interactive structure, an intermediate moveable component at least partially between the base component and the primary moveable component, and a cooperation mechanism on the intermediate moveable component, the cooperation mechanism configured to interact with the first interactive structure and the second interactive structure, such that movement of the primary moveable component causes movement of the intermediate moveable component in substantially the same direction as the primary moveable component.

In still another embodiment, a measuring device comprises a base component comprising at least one first jaw structure and at least one first interactive structure, a primary moveable component moveably connected to the base component, the primary moveable component comprising at least one second jaw structure and at least one second interactive structure, an intermediate moveable component comprising at least a first stop face at least partially aligned with the at least one first jaw structure and a second stop face at least partially aligned with the at least one second jaw structure, and a cooperation mechanism on the intermediate moveable component, the cooperation mechanism configured to interact with the first interactive structure and the second interactive structure, such that movement of the primary moveable component by a first displacement distance causes movement of the cooperation mechanism, which causes the intermediate moveable component to travel approximately one-half the first displacement distance in substantially the same direction as the primary moveable component.

These and other further features and advantages of the invention would be apparent to those skilled in the art from the following detailed description, taken together with the accompanying drawings, wherein like numerals designate corresponding parts in the figures, in which:

### BRIEF DESCRIPTION OF THE DRAWINGS

FIG. 1 is a front perspective view of an embodiment of a measuring device incorporating features of the present invention;

FIG. 2 is an exploded view of the embodiment of the measuring device of FIG. 1;

FIG. 3 is a front view of the embodiment of the measuring device of FIG. 1;

FIG. 4 is a front view of the embodiment of the measuring device of FIG. 1, shown in a different orientation;

FIG. 5 is a bottom view of the embodiment of the measuring device of FIG. 1, shown in a similar orientation to FIG. 4;

FIG. 6 is a right side sectional view of the embodiment of the measuring device of FIG. 1;

FIG. 7 is a front view of another embodiment of a measuring device incorporating features of the present invention; and

FIG. 8 is a front perspective view of yet another embodiment of a measuring device incorporating features of the present invention.

### DETAILED DESCRIPTION

The present disclosure will now set forth detailed descriptions of various embodiments. These embodiments set forth measuring devices capable of finding a given value of an object, for example, the center of an object. While the present disclosure will focus on devices configured to find the center of an object, the same principles shown and described herein can be utilized with embodiments of devices configured to find a different distance fraction of an object, for example, a distance off center of an object, even if overall size changes.

Devices incorporating features of the present invention can comprise a reduced number of parts. In some embodiments, devices according to the present disclosure comprise only four parts, including a manually-operated primary moveable component, an automatically-operated intermediate component, a stationary base component and a cooperation mechanism allowing interaction of the various components. These devices can be of a simple mechanical nature and can reduce the number of complex moving parts necessary for device operation.

In some embodiments, the cooperation mechanism comprises a gear connected to or otherwise on the intermediate moveable component, configured such that movement of the primary moveable component causes movement of both the gear and the intermediate moveable component. This configuration will be set forth in greater detail further below.

Throughout this description, the preferred embodiment and examples illustrated should be considered as exemplars, rather than as limitations on the present invention. As used herein, the term “invention,” “device,” “present invention,” or “present device” refers to any one of the embodiments of the invention described herein, and any equivalents. Furthermore, reference to various feature(s) of the “invention,” “device,” “present invention,” or “present device” throughout this document does not mean that all claimed embodiments or methods must include the referenced feature(s).

It is also understood that when an element or feature is referred to as being “on” or “adjacent” to another element or feature, it can be directly on or adjacent the other element or feature or intervening elements or features may also be present. It is also understood that when an element is referred to as being “attached,” “connected” or “coupled” to another element, it can be directly attached, connected or coupled to the other element or intervening elements may be present. In contrast, when an element is referred to as being “directly attached,” “directly connected” or “directly coupled” to another element, there are no intervening elements present.

Relative terms, such as “outer,” “above,” “lower,” “below,” “horizontal,” “vertical” and similar terms, may be used herein to describe a relationship of one feature to another. It is understood that these terms are intended to encompass different orientations in addition to the orientation depicted in the figures.

Although the terms first, second, etc. may be used herein to describe various elements or components, these elements or components should not be limited by these terms. These terms are only used to distinguish one element or component from another element or component. Thus, a first element or component discussed below could be termed a second element or component without departing from the teachings of the present invention. As used herein, the term “and/or” includes any and all combinations of one or more of the associated list items.

The terminology used herein is for describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” when used herein, specify the presence of stated features, integers, steps, operations, elements, and/or components, but do not preclude the presence or addition of one or more other features, integers, steps, operations, elements, components, and/or groups thereof.

Embodiments of the invention are described herein with reference to different views and illustrations that are schematic illustrations of idealized embodiments of the invention. As such, variations from the shapes of the illustrations as a result, for example, of manufacturing techniques and/or tolerances are expected. Embodiments of the invention should not be construed as limited to the particular shapes of the regions illustrated herein, but are to include deviations in shapes that result, for example, from manufacturing or specific applications of use.

It is understood that when a first element is referred to as being “between,” “sandwiched,” or “sandwiched between” two or more other elements, the first element can be directly between the two or more other elements or intervening elements may also be present between the two or more other elements. For example, if a first element is “between” or “sandwiched between” a second and third element, the first element can be directly between the second and third elements with no intervening elements or the first element can be adjacent to one or more additional elements with the first element and these additional elements all between the second and third elements.

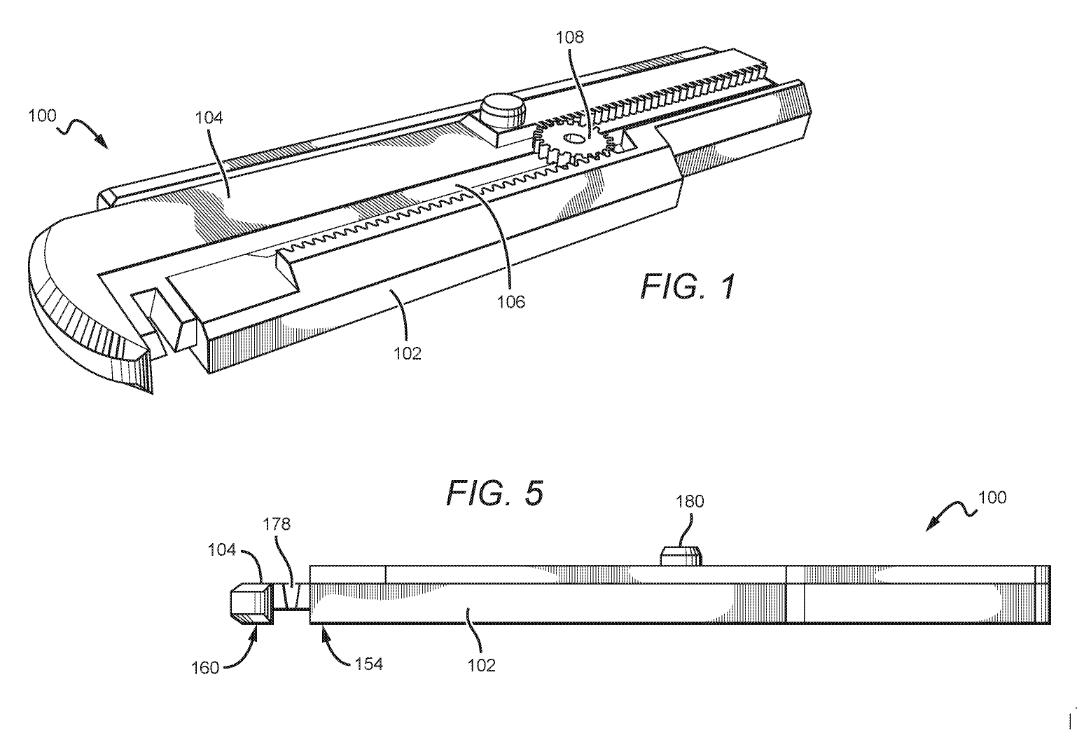

An embodiment of a measuring device 100 incorporating features of the present invention is shown in FIG. 1. The measuring device 100 generally comprises four main body components, which fit together as shown and described herein, although it is understood that the measuring device 100 can comprise additional features other than these four components, for example, the additional features described in the present disclosure and set forth further below. The four body components that the measuring device comprises can include: a base component 102, a primary moveable component 104, an intermediate moveable component 106, and a cooperation mechanism 108, which is configured to facilitate moveable cooperation between the four body components 102, 104, 106, 108.

The body components 102, 104, 106, 108 can comprise any suitable material that can support the structure and function of the measuring device 100, as set forth in the present disclosure including, but not limited to, resin, rubber, vinyl, polyurethane, poly vinyl chloride (PVC), Poly(methyl methacrylate) (PMMA), polystyrene foam, polymers/copolymer substances, acrylic substances, plastic, leather, metal, glass, fiberglass, wood, cloth or a combination thereof. The body components 102, 104, 106, 108 can also comprise any suitable material known in the art of tooling. The body components 102, 104, 106, 108 can be formed by any suitable method for example, molding, injection molding, stamping/pressing, three-dimensional printing, extrusion, machining, for example, CNC machining, milling, and/or any methods known in the art of tool manufacturing.

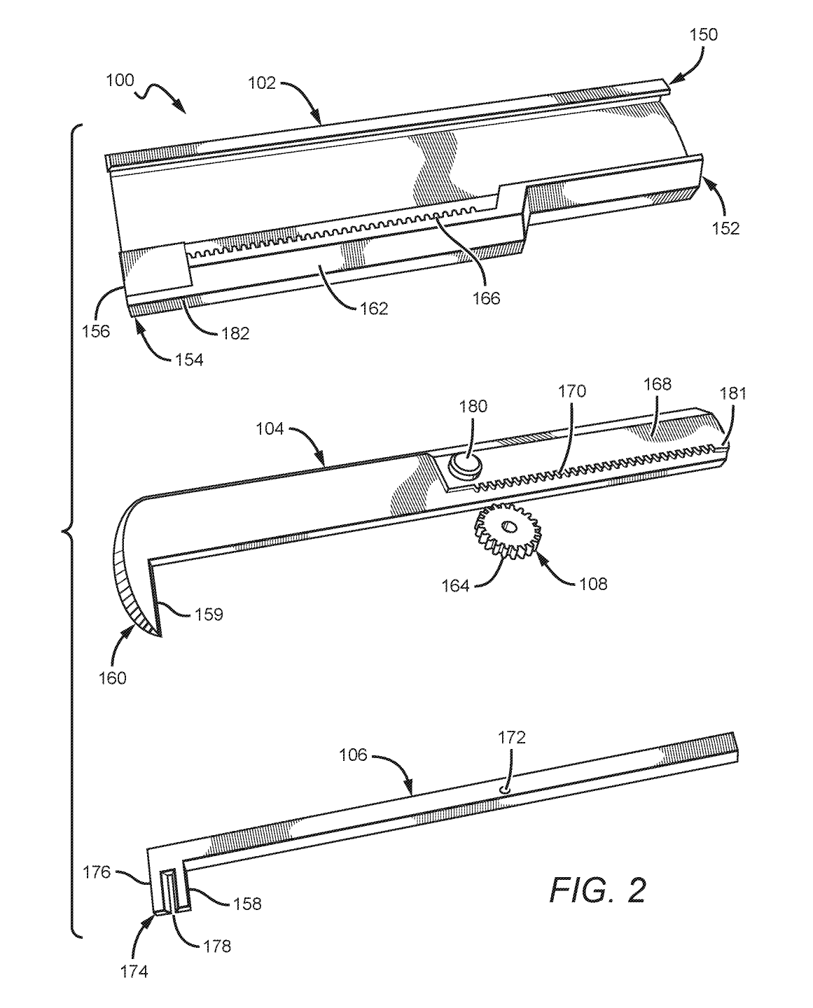

The individual body components 102, 104, 106, 108 of the measuring device 100 are now discussed in individual detail with reference to the exploded view of FIG. 2. The base component 102 can serve as a primary stationary or substantially stationary component to which the remaining components 104, 106, 108 are integrated with and/or connected to. Various portions of the base component 102 can be configured to specifically accommodate for or interact with one of the other components 104, 106, 108. For example, a portion of the base component 102 can comprise a female connection portion configured to accept a male connection partition on one of the remaining body components 104, 106, 108. The base component 102 can be configured such that it is of sufficient dimensions that a user can easily grip the base component 102 with a single hand.

The base component 102 can comprise one or more rail structures, with the embodiment shown in FIG. 2 comprising a first rail structure 150 and a second rail structure 152. These rail structures 150, 152 can correspond to complementary sliding structures on the primary moveable component 104 and the intermediate moveable component 106, to allow these components 104, 106 to be moveably connected to the base component 102. The rail structures 150, 152 can be configured such that the moveable components 104, 106 can be integrated with the base component 102 and slide and change position in relation to the stationary base component 102.

In the embodiment shown in FIG. 2, the rail structures 150, 152 comprise a female receiving structure, whereas the corresponding sliding structures of the moveable components 104, 106 comprise male sliding structures. While the embodiment of FIG. 2 sets forth a specific sliding structure configuration, it is understood that other sliding structure configurations, or indeed other configurations allowing the moveable components 104, 106 to be moveably connected to the base component 102 is within the scope of the present disclosure.

The base component 102 can further comprise one or more jaw structures, with a first jaw structure 154 shown in the embodiment of FIG. 2. The first jaw structure 154 is configured to serve a variety of purposes, including providing a first measuring parameter and functioning as a structural “stop” for the intermediate moveable component 106 when the measuring device 100 is in its retracted or resting position. In some embodiments, the first jaw structure 154 comprises a first inner face 156.

The first inner face 156 of the base component 102 can be configured such that a first stop face 158 of the intermediate moveable component 106 can be at least partially aligned with a portion of the base structure 102, for example, first jaw structure 154 and/or the first inner face 156. In some embodiments, the first stop face 158 can abut against the first inner face 156 when the device 100 is in its retracted or resting position. This configuration secures the intermediate moveable component 106 in place by preventing further movement of intermediate moveable component 106 in a direction toward the base component 102.

In the embodiment shown in FIG. 2, which is configured to be a right-handed device, the interaction between the first inner face 156 of the base component 102 and the first stop face 158 of the intermediate moveable component 106, will prevent the intermediate moveable component 106 from moving any further to the right when the two face structures 156, 158 abut against each other. In left-handed devices, such as the device shown in FIG. 7, the two faces can prevent the intermediate moveable component from progressing any farther to the left of the device.

The first inner face 156 also functions to provide a first measuring parameter, when the moveable components 104, 106 are extended. As will be discussed in greater detail below, an object to be measured can be positioned so that one side of the object abuts against the first inner face 156 of the first jaw structure 154 of the base component 102 and an opposite side of the object to be measured abuts against a second inner face 159 of one or more second jaw structures 160 (one shown), which can be located on the primary moveable component 104. This results in a linear dimension (e.g. length, width or height) of the object becoming sandwiched between the first inner face 156 and the second inner face 159. As will be discussed in greater detail further below, this allows the device 100 to automatically and continuously determine the center of an object.

The base component 102 can further comprise one or more first interactive structures 162 that are configured to interact with the cooperation mechanism 108, allowing movement between the various components as described herein. In the embodiment shown, wherein the cooperation mechanism comprises a gear-like structure comprising gear protrusions 164, the first interactive structure 162 comprises a first rack with first rack protrusions 166. In the embodiment shown in FIG. 2, the first interactive structure 162 is configured such that the first rack protrusions 166 can interact with the gear protrusions 164 on the cooperation mechanism 108, such that the cooperation mechanism 108 can move in relation to the first interactive structure 162.

The cooperation mechanism can be any mechanism suitable for allowing for movement of the primary moveable component 104 to translate into movement of the intermediate moveable component 106, or vice versa. In some embodiments, the cooperation mechanism 108 is configured to interact with one or more portions of the base component 102, the primary moveable component 104 and/or the intermediate moveable component 106. For example, the cooperation mechanism 108 can be configured such that it is sandwiched between the first interactive structure 162 on the base component 102 and a second interactive structure 168 on the primary moveable component 104.

In the embodiment shown, the second interactive structure 168, like the first interactive structure 162, comprises a rack structure 166, and further comprises second rack protrusions 170. In some embodiments, the cooperation mechanism 108 is not a separate component, but is instead or additionally integrated into one or more device parts, for example, being integrated into the base component 102, the primary moveable component 104, and/or the intermediate moveable component 106. In these embodiments, structures on these device parts 102, 104, 106 can interact with other structures on other device parts, such that the intermediate moveable component 106 moves when said base component 102 and/or said primary moveable component 104 moves.

The cooperation mechanism 108, the first interactive structure 162 and the second interactive structure 168 are configured together, such that movement of the primary moveable component 104, which causes the second inner face 159 to move farther apart from the first inner face 156, will cause the cooperation mechanism 108 to also move in substantially the same direction.

In the embodiment shown in FIG. 2, this is accomplished as movement of the primary moveable component 104 will cause the second rack protrusions 170 of the second interactive structure 168 to interact with the gear protrusions 164 of the cooperation mechanism 108, which will in turn interact with the first rack protrusions 166 of the first interactive structure 162. The result is the cooperation mechanism 108 moving in substantially the same direction as the primary moveable component 104 by “climbing” along the first interactive structure 162, due to the gear-like interaction of the gear protrusions 164, the first rack protrusions 166, and the second rack protrusions 170. The gear protrusions 164, the first rack protrusions 166, and the second rack protrusions 170 can be configured such that they are all equal in pitch and size to further increase device precision.

It is understood that while a rack and protrusion structure configuration for the first and second interactive structures 162, 168 is set forth in some embodiments herein, other structures configured to interact with and facilitate or otherwise affect movement between the cooperation mechanism, the base component, the primary moveable component and/or the intermediate moveable component are within the scope of the present disclosure, including any known structures.

The cooperation mechanism 108 can be connected to the intermediate moveable component 106 and configured such that when the cooperation mechanism moves in response to the primary moveable component 104 being moved by a user, the intermediate moveable component 106 also moves. The cooperation mechanism 108 can be connected to a connection point 172 on the intermediate moveable component 106 through any known connection structures or methods known in the art. In some embodiments, the cooperation mechanism 108 is connected to the connection point 172 through use of a mechanical fastener, for example, a snap-ring, screw or bolt structure. In the embodiment shown, the cooperation mechanism 108 is moveable and rotatably connected to the intermediate moveable component 106. In some embodiments, the cooperation mechanism 108 is configured such that it rotates about the connection point 172 as the intermediate component 106 moves.

Referring to the intermediate moveable component 106, the intermediate moveable component 106 can comprise one or more head portions 174 (one shown). The head portion 174 can comprise the first stop face 158, a second stop face 176 and/or one or more marking grooves 178. As mentioned previously, when the device 100 is in its resting or retracted position, the first stop face 158 of the intermediate moveable component 106 abuts against the first inner face 156 of the base component 102. Likewise, when the device is in its resting or retracted position, the second stop face 176 of the intermediate moveable component 106 can be at least partially aligned with a portion of the primary moveable component 104, for example, a different portion of said base structure 102 than the portion the first stop face 158 can be aligned with, for example, the second jaw structure 160 and/or the second inner face 159. In some embodiments, the second stop face 176 can abut against the second inner face 159 of the primary moveable component 104, such that the head portion 174 of the intermediate moveable component 106 is sandwiched between the first jaw structure 154 and the second jaw structure 160.

The marking groove 178 is positioned such that when the center of an object is located, as will be discussed in further detail below, a user can use his or her free hand, which is not operating the device 100, to take a writing instrument, such as a pencil or scribe, and utilize the marking groove 178 to place a mark on the object, thus marking the center portion. While devices incorporating features of the present invention can be operated with only a single hand, it is understood that these devices can also be operated with two hands should a user so desire.

The primary moveable component 104 can further comprise an operation structure 180, which allows a user to conveniently move and manipulate the primary moveable structure 102. In the embodiment shown in FIG. 2, the operation structure 180 comprises a protrusion that is connected to, and/or part of, the primary moveable component 104, such that it sufficiently protrudes from the device 100 when the primary moveable component 104 is coupled with the base component 102. An example use of the operation structure 180 is that a user can place his or her thumb on the operation structure 180, while gripping the base component 102 with the same hand. The user can then push the operation structure, such that the primary moveable component 104 retracts or extends in relation to the base component 102.

While the present embodiment includes an operation structure 180, it is understood that the operation structure is optional. The device 100 can instead not include an operation structure 180 or can include many different types of operation structures other than the protrusion embodiment explicitly disclosed. In some embodiments, the primary moveable component 104 is configured such that a user can use his or her thumb to directly move one or more direct portions of the moveable component 104, which will move the whole of the moveable component 104. This is possible because the primary moveable component 104 can comprise one or more portions that are exposed and can be manipulated through manual contact, as the primary moveable component 104 can be configured such that it is not completely surrounded or obstructed by said base component 102. In some embodiments, the primary moveable component is substantially unobstructed by said base component and can be manipulated at multiple points along its length. In other embodiments, it is the intermediate moveable component 106 that is configured to be directly operated by a user in lieu of or in addition to direct operation of the user of the primary moveable component 104.

In some embodiments, the device 100 can further comprise a first stop point 181, configured such that the when the device 100 is utilized, the range of motion of the primary moveable component 104 is restricted. The first stop point 181 can contact or otherwise interact with a portion of the cooperation mechanism 108 to restrict movement of the primary moveable component 104 to a desired range of motion, for example, preventing the disconnection of the primary moveable component 104 from the base component 102, by not allowing the primary moveable component 104 to be pulled too far in a direction away from the base component 102. Likewise, in some embodiments, the device 100 can also further comprise a second stop point 182 that can restrict the motion of the intermediate structure 106 and/or the cooperation mechanism 108 as is discussed herein.

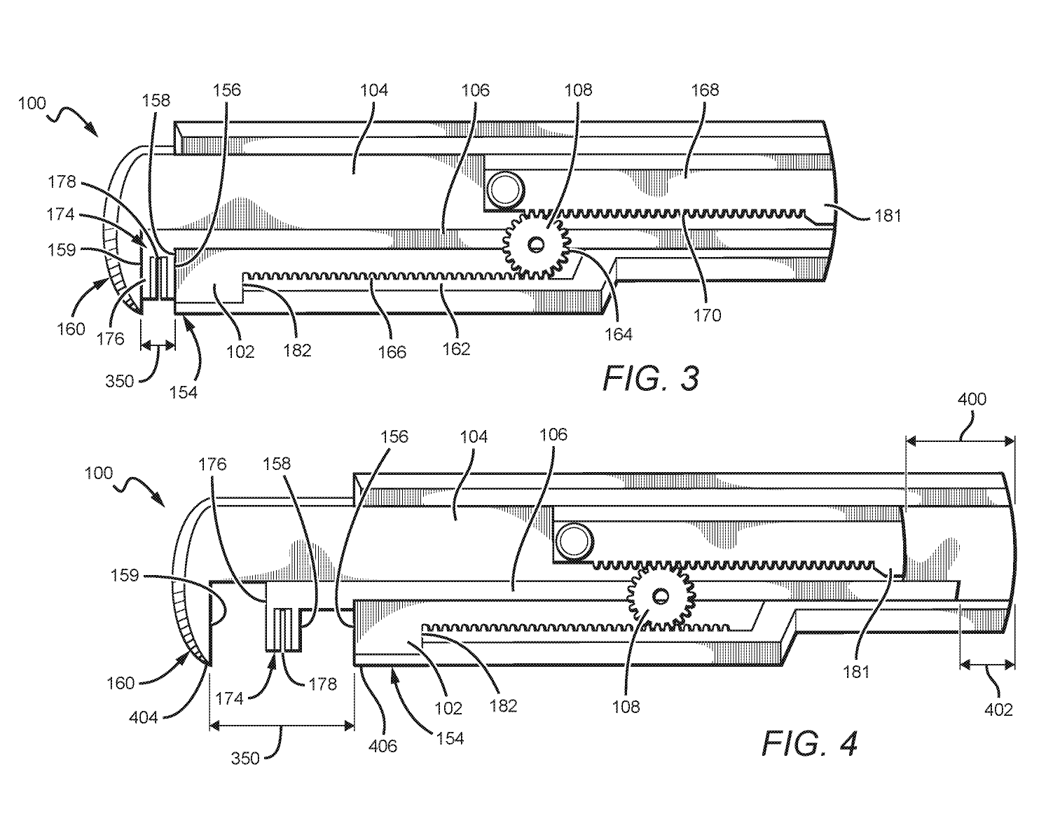

Referring to FIGS. 3-4, which show the interaction between the various device components and structures and the operation of the device, FIG. 3 shows the measuring device 100, comprising the base component 102, the primary moveable component 104, the intermediate moveable component 106, and the cooperation mechanism 108. FIG. 3 shows the device 100 assembled and in its retracted or resting position, wherein the first inner face 156 of the first jaw structure 154 abuts against the first stop structure of the head portion 174 of the intermediate structure 106 and the second inner face 159 of the second jaw structure 160 abuts against the second stop face 176 of the intermediate structure.

In the retracted or resting position, the device 100 comprises an operative space 350, which corresponds to the space between the first inner surface 156 of the first jaw structure 154 and the second inner face 159 of the second jaw structure 160. The various components of the device 100 are configured such that the center of the head portion 174 of the intermediate moveable component 106, including the marking groove 178 in embodiments utilizing the groove, is positioned automatically and continuously in the center of the operative space 350. For example, in embodiments wherein the operative space 350 is one inch when the device 100 is retracted, the marking groove 178 will be positioned at the half-inch mark. It is understood that some embodiments do not include a marking groove 178. In these embodiments, an arrow or other indicator can be used to further indicate the precise center of the head portion 174 of the intermediate moveable component 106 to a user. Accordingly, the linear distance value of the operative space 350 varies according to device operation.

The various components of the device 100 are configured such the center position of the marking groove 178 in the operative space 350 is maintained as the device is used. As discussed above, the second interactive structure 168 on the primary moveable component 104 can comprise second rack protrusions 170. As a user moves the primary moveable component 104, the second jaw structure 160 moves farther away from the first jaw structure 154 and thus widens the operative space 350. Due to the movement of the primary moveable component 104, the second interactive structure 168 also moves in substantially the same direction as the primary moveable component 104. The movement of the second interactive structure 168 causes the second rack protrusions 170 to interact with the gear protrusions of the cooperation mechanism 108, which will cause the cooperation mechanism to also move in substantially the same direction as the primary moveable component 104.

Since the cooperation mechanism 108 is connected to the intermediate moveable component 106, the intermediate moveable component 106 also moves in substantially the same direction as the primary moveable component 104. The gear protrusions 164 of the cooperation mechanism 108 then interact with the first rack protrusions 166 of the first interactive structure 162 of the base component 102. This configuration results in the movement of the primary moveable component 104 being controlled by the user, while the movement of the intermediate moveable component 106 is controlled by the interaction between the cooperation mechanism 108, the first interactive structure 162 and the second interactive structure 168. This results in the intermediate moveable component 106 moving at a ratio of one-half distance of the primary moveable component 104, in the direction that the primary moveable component 104 is moving. When a user narrows the operative space 350, the retraction of the primary moveable component 104 likewise causes the retraction of the cooperation mechanism 108 and the intermediate moveable component 106.

As the dimensions of the various components are pre-determined, for example, the placement of the interactive structures 162, 168, the pitch and size of the protrusions 164, 166, 170, and the cooperation component 108, the center of the head portion 174 of the intermediate moveable component 106 moves in relation to the first and second jaw structures 154, 160, such that the center of the head portion 174 is always located in the center of the operative space 350.

The protrusions 164, 166, 170 can be configured such that as the cooperation mechanism 106 moves in response to movement of the primary moveable component 104 (and can move in substantially the same direction as the primary moveable component), the intermediate moveable component 106 travels a different distance than the primary moveable component 104, for example, half the distance as the primary moveable component 106. This results in the distance between the first stop structure 158 of the head portion 174 and the first inner surface 156 of the first jaw structure 154 being equal to the distance between the second stop structure 176 of the head portion 174 and the second inner face 159 of the second jaw structure 160. For example, in the embodiment shown in FIG. 3, as the cooperation mechanism 108 “climbs up” the first interactive structure 162, it simultaneously “climbs down” the second interactive structure 168 and vice versa.

Hence, movement of the primary moveable component 104 can cause the cooperation mechanism 108 to climb the first interactive structure 162 in first direction, while simultaneously climbing said second interactive structure 168 in a substantially opposition direction. This causes the center of the head portion 174 to constantly be in the center of the operative space 350 whether the user is extending the primary moveable component 104 (and thus widening the operative space 350) or retracting the primary moveable component (and thus narrowing the operative space 350).

FIG. 4 further demonstrates the above functionality, showing the device 100 in an extended position. FIG. 4 shows the measuring device 100 comprising the base component 102, the primary moveable component 104, the intermediate moveable component 106, and the cooperation mechanism 108. FIG. 4 differs from FIG. 3 above in that the primary moveable component 104 has been displaced a first displacement distance 400 from its resting or retracted position, such that the second inner face 159 of the second jaw structure 160 is further away from the first inner face 156 of the first jaw structure 154, thus increasing the operative space 350 as compared to the resting operative space 350 shown in FIG. 3.

As shown in FIG. 4, the displacement of the first moveable component 104, causes the cooperation mechanism 108 to be displaced from its resting position by a first displacement distance 400, traveling in substantially the same direction, for example, traveling in substantially the same planar direction (e.g. vertically or horizontally depending on how the device is orientated) as the primary moveable component 104 and causing the connected intermediate moveable component 106 to be displaced a second displacement distance 402 from its resting position shown in FIG. 3.

These displacement distances 402 can be equal in magnitude (e.g. length) or different in magnitude depending on the desired configuration of the measuring device. In some embodiments, the various components can be configured such that the second displacement distance 402 traveled by the intermediate moveable component 106 is equal to, or substantially equal to, one-half of the first displacement distance 400 traveled by the primary moveable component 104. This results in the marking groove 178 always being at the center point between the operative space 350.

Accordingly, a user can utilize the measuring device 100 by displacing the primary moveable component 104 from its resting position, to widen the operative space 350 as set forth above. The user then places an object that he or she wants to measure or determine the center of between the two jaw structures 154, 160, such that the operative distance 350 is equal to the linear dimension (e.g. length, width, height) of the object that a user wants to measure. The marking groove 178 (or simply the center of the head portion 174 in embodiments without a marking groove) will be aligned with the center of the object to be measured due to the automatic corresponding displacement 402 of the intermediate moveable component 106 in relation to the user-controlled displacement 400 of the primary moveable component 104.

The jaw structures 154, 160 of the base component 102 and the primary moveable component 104 can be configured in a variety of ways and a user can operate the device 100 in a variety of different ways according to the present disclosure. For example, a user can widen the operative space 350 and place the device over an object to be measured and then slowly shorten the operative space 350 until one or more protruding portions 404, 406 (two shown) of the jaw structures 154, 160 catch on the object.

Another way a user can operate the device 100 includes lining the protruding portions 404, 406 up to an object being measured and narrowing the operative space 350 until the protrusions 404, 406 snugly fit the object. An alternate configuration of the device 100 can be implemented, which is particularly useful in measuring flat or substantially two-dimensional surfaces, such as paper. In this embodiment, there are no protruding portions 404, 406, such that the head portion 174 of the intermediate moveable component 106 is flush with the jaw structures 154, 160, such that the tool can lay flat when in use.

Also shown in FIGS. 3-4, is the first stop point 181 and the second stop point 182. As best shown in FIG. 4, when the primary moveable component 104 is being pulled in a direction away from the base component 102, for example, being moved the first displacement distance 400, the first stop point 181, which can be connected to or part of the primary moveable component 104, also moves in substantially the same planar direction. If the primary moveable component 104 is pulled too far in a direction away from the base component 102, the first stop point 181 can abut against the cooperation mechanism 108 and prevent further motion of the primary moveable component 104 in that direction, and therefore prevent disconnection of the primary moveable component 104 form the base component 102. Likewise, the second stop point 182, which can be connected to or part of the base component 102, can block further motion of the cooperation mechanism 108 in the direction the primary moveable component 104 is being moved away from the base component 102. This can occur as the cooperation mechanism (or alternative or additionally a portion of the intermediate moveable component) can abut against the second stop point 182 as it approaches the second stop point 102, preventing further movement in that direction.

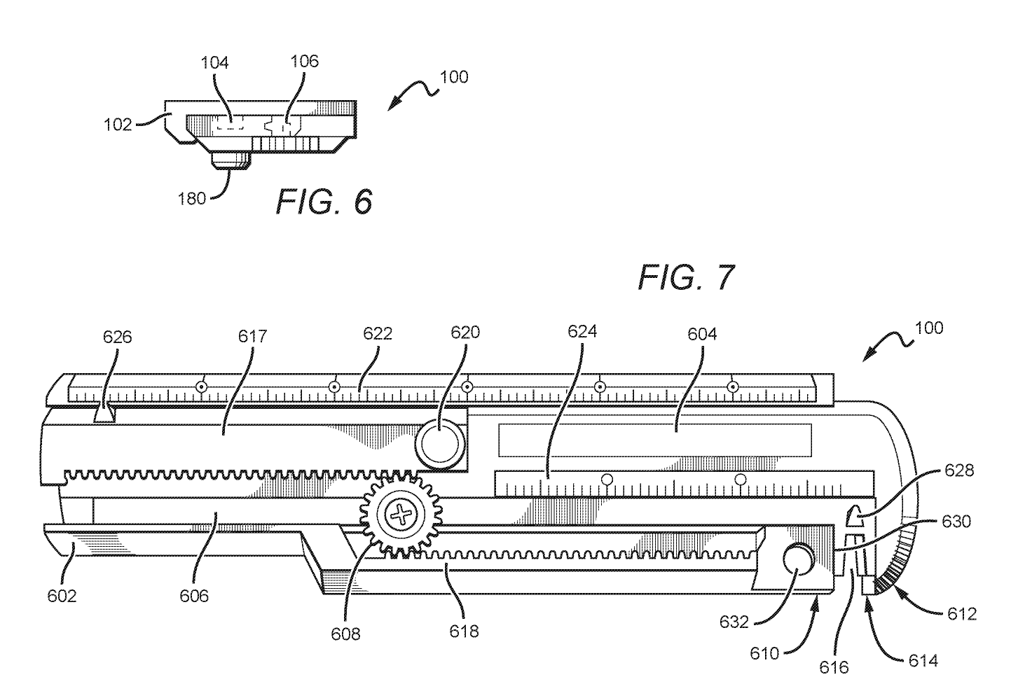

FIGS. 5-6 show a bottom view and a right-side sectional view of the measuring device 100 respectively, and thus help to further illustrate the configuration between the various features of the device 100 from additional viewing angles. FIG. 5 shows the base component 102, the primary moveable component 104, the first jaw structure 154, the second jaw structure 160, the marking groove 178, and the operation structure 180. FIG. 6 shows the base component 102, the moveable component 104, the intermediate moveable structure 106, and the operation structure 180.

FIG. 7 shows another embodiment of a measuring device 600, exhibiting some additional features and variations. Any of these additional features as set forth in FIG. 7 can also be included in the embodiment of FIGS. 1-6, or other embodiments described herein, and the features discussed with regard to FIG. 7 are compatible with the above disclosure of FIGS. 1-6. The measuring device 600 of FIG. 7, like the measuring device 100 in FIGS. 1-6 above, comprises a base component 602, a primary moveable component 604, an intermediate moveable component 606, a cooperation mechanism 608, a first jaw structure 610, a second jaw structure 612, a head structure 614 comprising a marking structure 616, a first interaction structure 617, a second interaction structure 618, and an operation structure 620.

Additionally, the measuring device 600 can comprise one or more measuring unit charts 622, 624 (two shown). The measuring unit charts are configured to correspond with one or more set points 626, 628 (two shown) on the device components such that various measurement values can be determined. For example, a first set point 626 can be configured with a first measuring unit chart 622 to correspond to the measured unit value (e.g. in inches or metric units) of the operative space 630. Likewise, a second set point 628 can be configured with a second measuring unit chart to correspond to the measured unit value of the center point of the operative space 630. Even in embodiment incorporating measuring charts, 622, 624, a user can ignore the charts and simply use the device 600 to be utilized to find the center of an object as set forth above.

In some embodiments, the measuring device 600 further comprises an attachment portion 632. The attachment portion 632 can be any known structure or method of attaching one object to another known in the art. The attachment portion 632 can comprise a variety of suitable structures, including, but not limited to: snap-fit structures, clips, holes, tie strings, hooks, and micro hook-and-loop structures (such as Velcro®). In the embodiment shown, the attachment portion 632 comprises a hole that can function such that the device 600 can be hung on a hook or protrusion (such as a nail) on a wall.

Another notable difference between the measuring device 600 of FIG. 7 and the measuring device 100 of FIGS. 1-6 above is that the measuring device 600 of FIG. 7 is in a left-handed orientation. This allows a user to more easily operate the device with his or her left hand, for example, by gripping the base component 602 and using the thumb of the left hand to push the operation structure 620 and displace the primary moveable component 604 to widen the operative space 630.

Some advantages of the devices incorporating features of the present invention over conventional measuring devices include that the devices according to the present disclosure can be made with fewer parts and thus are more stable, have fewer components to break down and have a longer useful life; these devices are also less expensive to manufacture. These devices also comprise an intermediate moveable component that continuously and automatically finds the center of an object. There is no need for the device to be reset or for additional calculations. A user can sequentially measure multiple different-sized objects back-to-back without slowing down and as the operative space changes, so does the intermediate moveable component pointing to a different value of center. Furthermore, devices incorporating features of the present invention can be easily operated with a single hand, allowing a user to use his or her other hand freely.

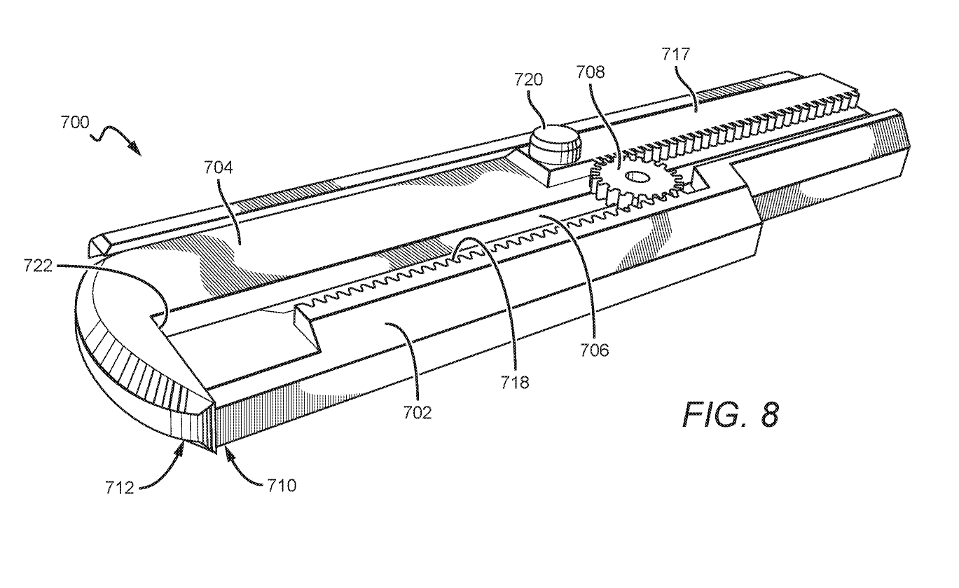

FIG. 8 shows another embodiment of a measuring device 700, exhibiting some additional features and variations. Any of these variations and/or additional features as set forth in FIG. 8 can also be included in the embodiment of FIGS. 1-6, or other embodiments described herein, and the features discussed with regard to FIG. 8 are compatible with the above disclosure of FIGS. 1-6. The measuring device 700 of FIG. 8, like the measuring device 100 in FIGS. 1-6 above, comprises a base component 702, a primary moveable component 704, an intermediate moveable component 706, a cooperation mechanism 708, a first jaw structure 710, a second jaw structure 712, a first interaction structure 717, a second interaction structure 718, and an operation structure 720.

Unlike the embodiment set forth with regard to FIGS. 1-6 above, the embodiment set forth in FIG. 8 does not comprise a head portion 174 or a corresponding marking groove 178. It is important to note that in embodiments of devices incorporating features of the present invention, the use of a head portion 174 is not required. In these embodiments, for example, the embodiment of FIG. 8, a specific point, for example, a center point on an object, can be determined by positioning portions of the object between the first jaw structure 710 and the second jaw structure 712 as described herein and having one or more portions of the intermediate moveable component 706 component, for example, a determination edge 722, correspond to the half-way point between the distance between extended first and second jaw structures 710, 712, in lieu of a head portion. As shown in FIG. 8, the determination edge 722 of the intermediate moveable component 706 can abut against the first jaw structure 712 when the device is in an unexpended “resting” position.

Although the present invention has been described in detail with reference to certain preferred configurations thereof, other versions are possible. Embodiments of the present invention can comprise any combination of compatible features shown in the various figures, and these embodiments should not be limited to those expressly illustrated and discussed. Therefore, the spirit and scope of the invention should not be limited to the versions described above.

The foregoing is intended to cover all modifications and alternative constructions falling within the spirit and scope of the invention as expressed in the claims, wherein no portion of the disclosure is intended, expressly or implicitly, to be dedicated to the public domain if not set forth in any claims.

I claim:

1. A measuring device, comprising:
a base component comprising at least one first jaw structure;
a primary moveable component moveably connected to said base component, said primary moveable component comprising at least one second jaw structure; and
an intermediate moveable component comprising at least a first stop face at least partially aligned with said at least one first jaw structure and a second stop face at least partially aligned with said at least one second jaw structure, said intermediate moveable component configured to move in response to movement of said primary moveable component.

2. The measuring device of claim 1, wherein said device is configured such that movement of said primary moveable component by a first displacement distance causes movement of said intermediate moveable component in substantially the same planar direction by approximately one-half said first displacement distance.

3. The measuring device of claim 1, wherein said primary moveable component is substantially unobstructed by said base component.

4. The measuring device of claim 1, wherein said primary moveable component is moveably connected to said base component by one or more rail structures.

5. The measuring device of claim 1, further comprising an operation structure on a portion of said primary moveable component other than said second jaw structure, said operation structure configured such that movement of said operation structure causes movement of said primary moveable component.

6. The measuring device of claim 1, wherein said intermediate moveable component further comprises one or more marking grooves.

7. The measuring device of claim 1, further comprising a cooperation mechanism on said intermediate structure, said cooperation mechanism configured to interact with said base component and said primary moveable components such that movement of said primary moveable component causes controlled movement of said intermediate moveable component.

8. The measuring device of claim 7, wherein said cooperation mechanism comprises a gear structure comprising gear protrusions configured to interact with rack structures comprising rack protrusions on said base component and said primary moveable component.

9. The measuring device of claim 8, wherein movement of said primary moveable component in a first direction causes movement of said cooperation mechanism in substantially the same direction as said primary moveable component.

10. The measuring device of claim 7, wherein movement of said primary moveable component in a first direction causes movement of said cooperation mechanism in said first direction.

11. A measuring device, comprising:
a base component comprising at least one first interactive structure;
a primary moveable component moveably connected to said base component, said primary moveable component comprising at least one second interactive structure;
an intermediate moveable component at least partially between said base component and said primary moveable component; and
a cooperation mechanism on said intermediate moveable component, said cooperation mechanism configured to interact with said first interactive structure and said second interactive structure such that movement of said primary moveable component causes movement of said intermediate moveable component in substantially the same direction as said primary moveable component.

12. The measuring device of claim 11, wherein said device is configured such that movement of said primary moveable component by a first displacement distance causes movement of said intermediate moveable component in substantially the same planar direction by approximately one-half said first displacement distance.

13. The measuring device of claim 11, wherein said primary moveable component is substantially unobstructed by said base component.

14. The measuring device of claim 11, wherein said primary moveable component is moveably connected to said base component by one or more rail structures.

15. The measuring device of claim 11, wherein said intermediate moveable component further comprises one or more marking grooves.

16. The measuring device of claim 11, wherein said cooperation mechanism comprises a gear structure comprising gear protrusions.

17. The measuring device of claim 16, wherein said first interactive structure and said second interactive structure comprise rack structures comprising rack protrusions.

18. The measuring device of claim 17, wherein movement of said primary moveable component causes said gear structure to climb said first interactive structure in a first direction and climb said second interactive structure in a substantially opposite direction.

19. The measuring device of claim 11, wherein movement of said primary moveable component in a first direction causes movement of said cooperation mechanism in said first direction.

20. A measuring device, comprising:
a base component comprising at least one first jaw structure and at least one first interactive structure;
a primary moveable component moveably connected to said base component, said primary moveable component comprising at least one second jaw structure and at least one second interactive structure;
an intermediate moveable component comprising at least a first stop face at least partially aligned with said at least one first jaw structure and a second stop face at least partially aligned with said at least one second jaw structure; and
a cooperation mechanism on said intermediate moveable component, said cooperation mechanism configured to interact with said first interactive structure and said second interactive structure such that movement of said primary moveable component by a first displacement distance causes movement of said cooperation mechanism which causes said intermediate moveable component to travel approximately one-half said first displacement distance in substantially the same direction as said primary moveable component.
